(19) United States
(12) Patent Application Publication
(10) Pub. No.: US 2019/0043329 A1
(43) Pub. Date: Feb. 7, 2019

(54) SYSTEM AND METHOD FOR MONITORING AN INDIVIDUAL BY A SINGLE MONITOR AND OR A SOCIAL NETWORK

(71) Applicant: Lovie Gnell FITZPATRICK, Prevost (CA)

(72) Inventor: Lovie Gnell FITZPATRICK, Prevost (CA)

(21) Appl. No.: 16/042,109

(22) Filed: Jul. 23, 2018

Related U.S. Application Data
(60) Provisional application No. 62/535,312, filed on Jul. 21, 2017.

(51) Int. Cl. G08B 21/02; G08B 21/20

(52) U.S. Cl. CPC G08B 21/0266; G08B 21/0269; G08B 21/20; G08B 21/0288; G08B 21/0275

(57) ABSTRACT

A system for monitoring an individual comprising a controller arrangement comprising a memory of computer implemented steps and a database of predetermined target conditions. A monitoring device is physically associated with the monitored individual and in communication with the controller arrangement. The monitoring device provides for detecting a real-time condition status of the monitored individual. An interface accessible to a monitor of the individual is in communication with the controller arrangement and the monitoring device. The memory of computer implementable steps comprises: receiving the real-time condition status from the monitoring device; comparing the real-time condition status with the target conditions so as to identify a match; signaling the monitor via the interface when a match between a given real-time condition status and a target condition has been made. The system may further comprise a plurality of additional interfaces accessible to a network of users. The plurality of additional user interfaces are in communication with the controller arrangement. The network of users or a selected sub-group thereof are selectively notified of the target condition via the plurality of additional interfaces.

### CROSS-REFERENCE TO RELATED APPLICATIONS

The present application claims priority on United States Patent Provisional Patent Application No. 62/535,312 filed on Jul. 21, 2017 and incorporated herein by reference in its entirety.

### TECHNICAL FIELD

The present disclosure generally relates to the safety of individuals such as children requiring supervision. More particularly, but not exclusively, the present disclosure relates to a system and method for monitoring an individual by a single monitor and/or a social network.

### BACKGROUND

According to FBI figures, every 40 seconds, a child goes missing or is abducted in the United States. An average of 37 babies die in hot cars according to the US National Safety Council. It is difficult for parents or teachers to track and monitor children on their own and to act if an event such as the child being abducted, forgotten in a hot or cold place, getting lost, falling into a pool or a lake when not supervised. Other individuals such as seniors or adults with health conditions also require real time supervision and it is difficult for a single monitor to provide such supervision.

### OBJECTS

An object of the present disclosure is to provide a system for monitoring an individual.

An object of the present disclosure is to provide method for monitoring an individual.

### SUMMARY

In accordance with an aspect of the present disclosure, there is provided a system for monitoring an individual comprising: a controller arrangement comprising a memory of computer-implementable steps and a database of predetermined target conditions; a monitoring device physically associated with the monitored individual and in communication with the controller, the monitoring device providing for detecting a real-time condition status of the monitored individual; an interface accessible to a monitor of the individual being in communication with the controller arrangement and the monitoring device, the memory of computer implementable steps comprising: receiving the real-time condition status from the monitoring device; comparing the real-time condition status with the target conditions so as to identify a match; signaling the monitor via the interface when a match between a given real-time condition status and a target condition has been made.

In accordance with an aspect of the present disclosure, there is provided a device for monitoring an individual comprising: a monitor controller comprising a memory of computer-implementable steps and a database of predetermined target conditions; a monitoring device physically associated with the monitored individual and in communication with the controller, the monitoring device providing for detecting a real-time condition status of the monitored individual; an interface accessible to a monitor of the individual being in communication with the controller arrangement and the monitoring device, the memory of computer implementable steps comprising: receiving the real-time condition status from the monitoring device; comparing the real-time condition status with the target conditions so as to identify a match; signaling the monitor via the interface when a match between a given real-time condition status and a target condition has been made.

In an embodiment, the target condition is selected from a group of conditions consisting of: an unauthorized distance between the monitoring device and the monitor, an unauthorized distance between the monitoring device and another element, an unauthorized location of the monitoring device, an unauthorized velocity of the monitoring device, an unauthorized motion of the monitoring device, a unauthorized moisture level of the monitoring device, an unauthorized temperature level of the device, an unauthorized light intensity in the ambient environment of the monitoring device, an unauthorized sound in the ambient environment of the monitoring device, an unauthorized word in the ambient environment of the monitoring device and any combination thereof. In an embodiment, one or more of the group of condition is considered a target condition based on one or more additional conditions selected from the group consisting of: the duration of the condition; the time of day of the condition; the location of the condition; the frequency of the condition; and the concurrent presence of one or more other conditions of the group of conditions. In an embodiment, the another element is selected from the group consisting of a third-party controller, another monitoring device and a combination thereof.

In an embodiment, a match is identified if at least one of the following parameters is satisfied: if a given condition status matches a given target condition for a given time interval; if a given condition status matches a given target condition during a given time of the day; if a given condition status matches a given target condition at a given location; if a given condition status concurrently matches at least two given target conditions; and any combination thereof.

In an embodiment, a match is identified if a given condition status matches a given target condition at a given location.

In an embodiment, a match is identified is a given condition status concurrently matches at least two given target conditions.

In an embodiment, the monitoring device is selected from the group consisting of: a GPS, a RFID unit, a Bluetooth unit, an emitter, a sensor, a detector, a moisture sensor, a motion detector, a light detector, a temperature detector, a microphone, an application running on the processor of a host device, a controller with a memory of computer implementable steps and any combination thereof.

In an embodiment, the monitoring device is an assembly comprising a plurality of devices.

In an embodiment, the monitoring device is mounted to an appendage mounted or carried by the monitored individual. In an embodiment, the appendage is selected from the group consisting of: a bracelet, a necklace, a watch, eyewear, rings, earrings, headwear, shoes, a belt, clothing, socks, a shirt, a jacket, pants, underwear, accessories, a wallet, a bag, a handheld device, a smartphone, a tablet and any combination thereof.

In an embodiment, the controller arrangement comprises a remote system controller in communication with a monitor controller in communication with the interface. In an embodiment, the memory of computer implementable steps is hosted on the system controller and/or the monitor controller. In an embodiment, the database of target conditions is hosted on the system controller and/or the monitor controller.

In an embodiment, the system herein comprises a plurality of additional interfaces accessible to a network of users, the plurality of additional user interfaces being in communication with the controller arrangement. In an embodiment, the network of users or a selected sub-group thereof are selectively notified of the target condition via the plurality of additional interfaces.

In an accordance with an aspect of the present disclosure, there is provided a method for monitoring an individual comprising: providing a database of predetermined target conditions; detecting a real-time condition status of the monitored individual; comparing the real-time condition status with the target conditions so as to identify a match; and signaling a monitor via an interface accessible to the monitor when a match between a given real-time condition status and a target condition has been made.

In an embodiment, the method further comprises selectively notifying a plurality of selected method users via additional interfaces of the match.

In an embodiment of the method, the target condition is selected from a group of conditions consisting of: an unauthorized distance between the monitoring device and the monitor, an unauthorized distance between the monitoring device and another element, an unauthorized location of the monitoring device, an unauthorized velocity of the monitoring device, an unauthorized motion of the monitoring device, a unauthorized moisture level of the monitoring device, an unauthorized temperature level of the device, an unauthorized light intensity in the ambient environment of the monitoring device, an unauthorized sound in the ambient environment of the monitoring device, an unauthorized word in the ambient environment of the monitoring device and any combination thereof. In an embodiment, one or more of the group of condition is considered a target condition based on one or more additional conditions selected from the group consisting of: the time frame of the condition; the time of day of the condition; the location of the condition; the frequency of the condition; and the concurrent presence of one or more other conditions of the group of conditions. In an embodiment, a match is identified if at least one of the following parameters is satisfied: if a given condition status matches a given target condition for a given time interval; if a given condition status matches a given target condition during a given time of the day; if a given condition status matches a given target condition at a given location; if a given condition status concurrently matches at least two given target conditions; and any combination thereof.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic representation of the system of monitoring an individual in accordance with a non-restrictive illustrative embodiment of the present disclosure;

FIG. 2 is a schematic representation of the monitor controller of the system of FIG. 1 and communication with the monitoring device and monitor interface in accordance with a non-restrictive illustrative embodiment of the present disclosure;

FIG. 3 is a schematic representation of the system controller of the system of FIG. 1 in communication with the monitoring device and monitor interface in accordance with a non-restrictive illustrative embodiment of the present disclosure;

FIG. 4 is a schematic representation of the controller arrangement of the system of FIG. 1 in communication with a pair of intercommunicating monitoring devices, one for a monitor and the other for the monitored individual in accordance with a non-restrictive illustrative embodiment of the present disclosure;

FIG. 5 is a schematic representation of the controller arrangement of the system of FIG. 1 in communication with a pair of intercommunicating monitoring devices, each for a respective monitored individual; and

FIG. 6 is a schematic representation of the system of monitoring an individual showing various operational communication links therebetween in accordance with a non-restrictive illustrative embodiment of the present disclosure.

### DETAILED DESCRIPTION OF ILLUSTRATIVE EMBODIMENTS

Generally stated and in accordance with an aspect of the present disclosure, there is provided a system for monitoring an individual comprising a controller arrangement comprising a memory of computer implemented steps and a database of predetermined target conditions. A monitoring device is physically associated with the monitored individual and in communication with the controller arrangement. The monitoring device provides for detecting a real-time condition status of the monitored individual. An interface accessible to a monitor of the individual is in communication with the controller arrangement and the monitoring device. The memory of computer implementable steps comprises: receiving the real-time condition status from the monitoring device; comparing the real-time condition status with the target conditions so as to identify a match; signaling the monitor via the interface when a match between a given real-time condition status and a target condition has been made. The system further comprises a plurality of additional interfaces accessible to a network of users. The plurality of additional user interfaces being in communication with the controller arrangement. The network of users or a selected sub-group thereof are selectively notified of the target condition via the plurality of additional interfaces.

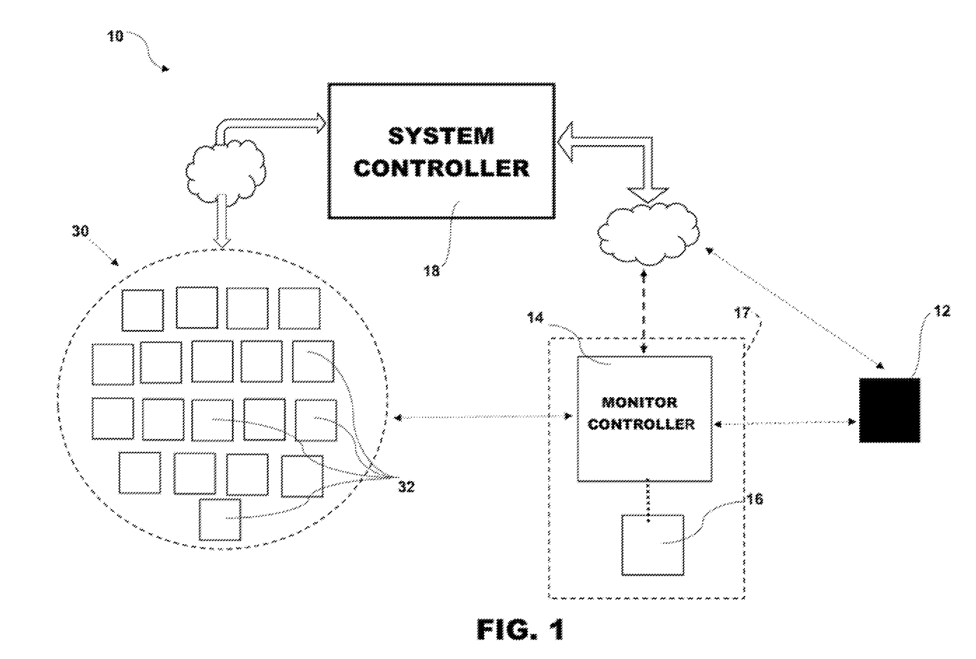

FIG. 1 shows a system 10 for monitoring an individual. This individual is physically associated with a monitoring device 12. In one embodiment, the individual wears the monitoring device 12 that may be integrated into an appendage including a bracelet, a necklace, a watch, eyewear, rings, earrings, headwear, shoes, a belt, clothing including a scarf, socks, a shirt, a jacket, pants, underwear, and other types of convenient accessories. Thus, in an embodiment, the device 12 can be mounted on an individual via the appendage. In another embodiment, the individual carries the device 12 which may be integrated into a wallet, a bag or another like accessory. Moreover, the device 12 may be integrated within another device such as a handheld device, a smartphone, a tablet and the like. Thus, the device 12, may be an application that is run within a processor of a host device. As will be further explained below, the device 12 may be an assembly of a plurality of devices. This plurality of devices may communicate with one another within the context of the present disclosure. Individuals requiring monitoring may be children, seniors, incapacitated adults, people suffering from a physical, mental or psychological condition requiring monitoring.

The device 12 is in communication with a controller arrangement.

In this example, the controller arrangement comprises a monitor controller 14 and a remote system controller 18.

Monitor controller 14 is in communication with a monitor interface 16. Controller 14 and interface 16 may be integrated items of a single handheld device 17, they may be connected via wiring, or they may be two separate bodies in wireless communication. The monitor controller 14 is also in communication with a remote system controller 18. The controller 14 and interface 16 are used by a monitor such as a parent in the case of the monitoring a child, a health care professional in the case of a person with a health condition that requires monitoring, a caregiver for monitoring a care recipient, a teacher for monitoring an underage student etc.

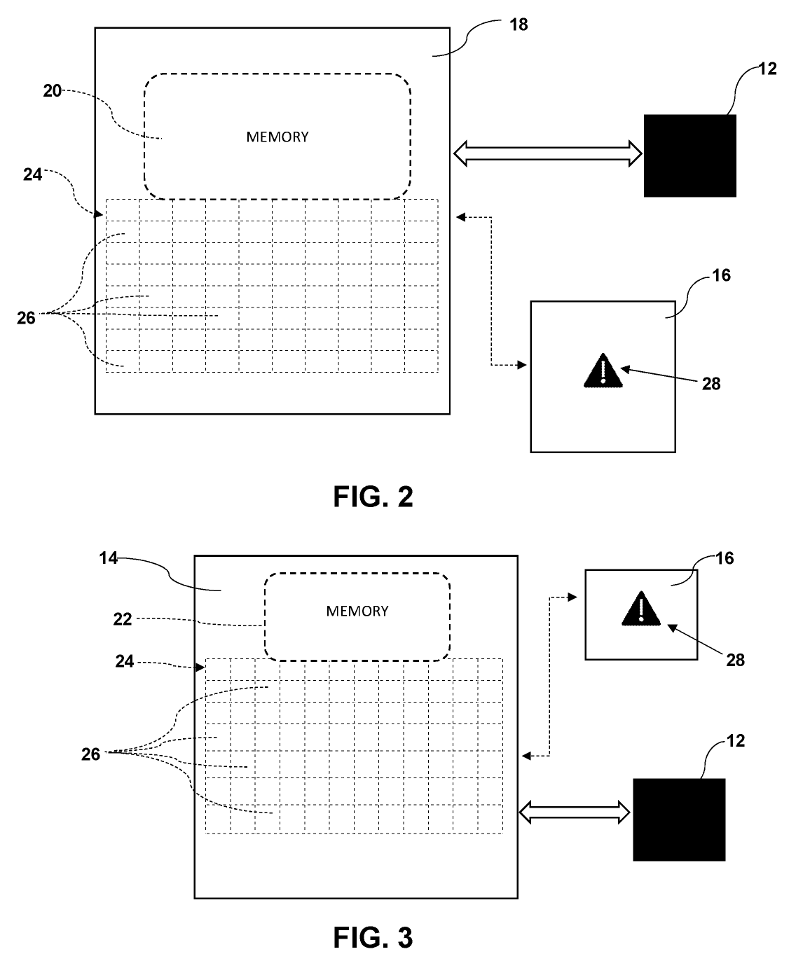

As shown in FIGS. 2 and 3, the controller arrangement comprises a memory of computer implementable steps. More specifically, but nor exclusively, the system controller 18 and the monitor controller 14 comprise respective memories, 20 (see FIG. 2) and 22 (see FIG. 3), of computer implementable steps.

The monitoring device 12 may comprise a GPS, a RFID unit, an emitter, a sensor, a detector, a moisture sensor, a motion detector, a light detector, a temperature detector, a microphone, an application running on the processor of a host device, a controller (e.g. micro-processor) with a memory of computer implementable steps and other types of suitable tracking devices within the context of the present disclosure and any combination thereof.

In an embodiment, the device 12 may be an assembly of various devices. These various devices of the assembled device may be mounted to the same or various appendages on the same user. For example, in a non-limiting embodiment, the device 12 comprises an assembly including a bracelet, a watch, and running shoes. The bracelet comprises a GPS unit, the watch comprises a moisture detector and the running shoes comprise a motion detector. The foregoing detectors being in communication with the monitor controller 14.

The memory 22 of the monitoring controller 14 comprises the step of detecting a target condition of device 12. This target condition may include an unauthorized distance between controller 14 and device 12, an unauthorized location of device 12, an unauthorized velocity during movement of device 12, a trigger light intensity detected by the device 12, a trigger motion detected by the device, a trigger temperature detected by the device 12, a trigger moisture level detected by the device 12, a trigger sound detected by the device. The foregoing target conditions may also be dependent on the time frame of the condition, the frequency of the condition or on the time of the day that this condition occurs in order to be considered target conditions.

One or both of the controller 14 and/or 18 comprise a databank 24 of target conditions 26. The controller 14 receives a real-time condition status from device 12. The controller 14 implements the step of comparing in real time the condition status received with the target conditions 26 in the databank 24. If a match is provided between a real-time condition status and a target condition 26, the controller implements the step of signaling the matched target condition 26 to the monitor (parent, teacher, caregiver, health care professional etc.) via the interface 16 by way of a signal 28 which can be a visual message, an audio message, a vibration or any combination thereof.

Alternatively, the controller 18 implements the comparison step with real time information received from the controller 14 and/or the device 12 and communicates the matched target condition to the controller 14 which signals the monitor via interface 16.

For example, a child associated with the device 12 may move away from their parent (the monitor) who is holding a handheld device comprising the controller 14 and the interface 16. The parent and child may be at a public place (such as a mall) and an unauthorized distance is detected between the two and signaled to the parent. In another example, during the time of day that the child should be at school, and the child is at another location, this different location is detected and signaled to the parent, teacher etc. In another example, the child being monitored is moving at an unauthorized velocity (such as being in a vehicle) during the time the child is supposed to be walking from school to another activity. This unauthorized velocity is signaled to the parent. In another embodiment, the motion detector of the device 12 detects unauthorized motions such as a child being swooped up, carried, or the child struggling, these unauthorized motions are target conditions 26 that are signaled to the parent, the teacher, the invigilator, the supervisor etc. In another non-limiting example, the moisture detector of the device 12, detects a high level of moisture indicative of the child being in water (pool, lake etc.) this target condition is signaled to the monitor. In another example, the light detector of the device 12 detects a lack of sufficient light during an unauthorized time of day (e.g. noon), for an unauthorized time frame; this condition status is indicative of a child being in an enclosed area lacking light, this condition status is matched with a target condition 26 and signaled to the monitor via the interface 16. In another embodiment, a target condition 26 can be an unauthorized, low or high temperature (e.g. indicating outdoors). In yet another example, the target condition 26 may be an unauthorized sound indicative of accident, gun shot, alarm, yelling, crying etc. In still another example, the target condition 26 may be a word, such as Help. Of course, a variety of target conditions can be contemplated within the scope of the present disclosure and included within the database 24.

When the monitor receives a message 28, the monitor computer implemented step provide the monitor with several options such as to ignore the signal since this is a one-time authorized target condition (e.g. a child getting a lift from a relative to go to a clinic during school hours) or to take an emergency action. Such as calling the school, the supervisor, stopping a child before it physically moves too far or going back to a car after having forgotten the child (or infant) therein.

Turning back to FIG. 1, the system comprises a social network 30 of users accessing data from the controller arrangement via interfaces 32.

In an embodiment, the monitor may signal the target condition 26 to the social network 30 (or a selected sub-group of that social network 30). For example, a parent may signal people in their selected sub-group of the social network (i.e. relatives and close friends) that their child is moving at an unauthorized speed within an unauthorized location. This allows the members of this sub-group to immediately ascertain a situation and act much like a neighborhood watch. In another embodiment, if the monitor receives a signal 28 but does not take any action, then the signal 28 can be sent to one or more members of a selected sub-group of the social network 30 with an indication that the initial monitor did not act upon receiving the signal 28. This can avoid events where a parent's handheld device is not functioning or cannot otherwise be reached due to a number of circumstances.

Communication between the interface 16 and the interfaces 32 is implemented by the system controller 18.

In an embodiment, the controller 18 can determine the physical proximity of an interface 16 user and other interface 32 users by way of the respective user controllers and can provide this information to other user controllers within a social network or sub-group thereof in accordance with pre-approved parameters. In another embodiment, the controller 18 provides a social network 30 of a plurality of users, each with an interface 32 associated to a personal user controller and in communication with the controller 18 and selectively with other controllers 14. If a controller 14 signals interface 16 it can also signal interfaces 32 that are associated to controllers of the network 30 which are in proximity to the signaling controller 14. In certain situations, for example, a child associated to the device 12 has drifted from their parent in possession of controller 14 in a public space and the parent cannot locate the child 12, the parent may request that an urgent signal be sent to anyone in the social network 30 that is within close proximity (within a predetermined range) to the controller 14 or to the device 12. In another embodiment, the parent with the controller 14 may not act upon being signaled, and as such an automatic signal is sent to other members of the social network 30 that are in proximity to the controller 14 and/or device 12. Once again, this provides a network community to act as a neighborhood watch for the protection of the monitored individual.

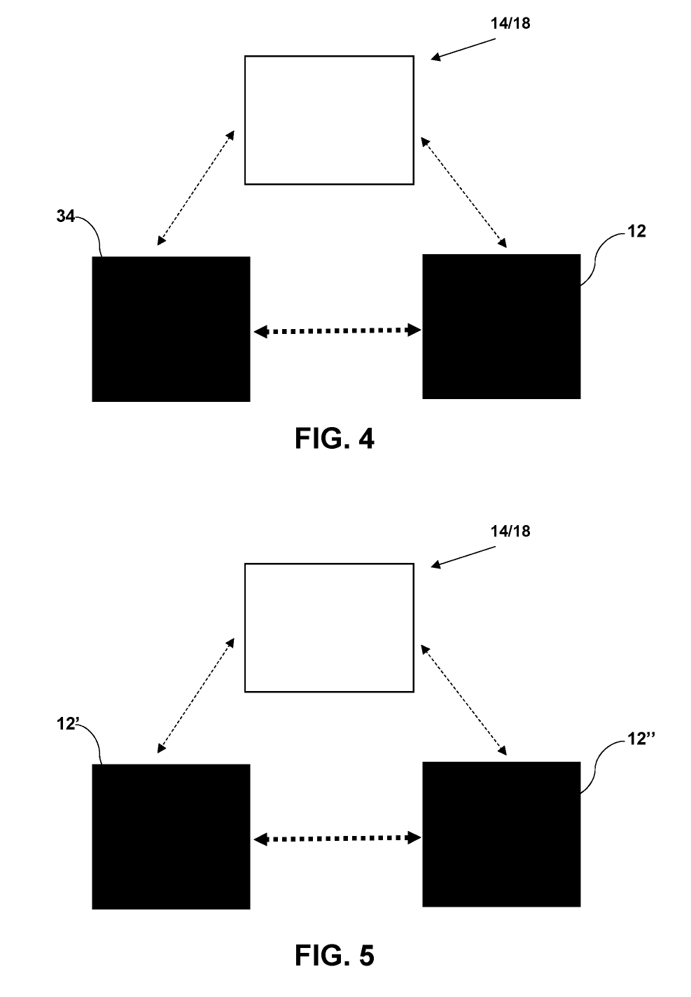

In an embodiment and with reference to FIG. 4, the monitor also has a similar monitoring device 34 to device 12 both of which are in communication with the controller 14 and/or the controller 18. The monitoring device 34 can also be provided in the form of an appendage similarly to device 12. Controller 14 or 18 detects unauthorized distance between devices 32 and 12 and this is signaled as a target condition 26.

In an embodiment, the monitor controller 14 or 18 communicates with more than one device 12.

In an embodiment, the device 12 communicates with more than one controller 14 and interface 16.

In an embodiment, the device 34 communicates with more than one device 12.

In an embodiment and with reference to FIG. 5, the controller 14 and/or 18 supervises more than one individual associated to a respective device 12′ and 12″; a target condition 26 may be an unauthorized distance between devices 12′ and 12″.

In an embodiment, there is provided a plurality of bracelets comprising the device 12. These bracelets are worn by children. The parents (or legal guardians) of the children have handled devices comprising the controller 14 and the interface 16. All the bracelets (communicate with all the handheld devices). Therefore, all the children of this social network or community are linked to all the parents of this social network or community. In an embodiment, this communication can be provided by Bluetooth If none of the parents' handheld devices receives a signal from a given one of the bracelets, this is a target condition indicative of an authorized distance between the device 12 and all the controllers 14 of the community. In this scenario, that given child is out of range (off grid) from the community. All the handheld devices signal to all the parents of this community that a given one of the children is out of range. A picture may be sent to all the handheld devices by the controller 14 of the missing child. Information regarding the last in range (on grid) position may be sent to all the parents of the community thus providing a better possibility of locating the child. The controller 14 can provide a map of all the parents and/or children in the community in real time or at a given time or upon request. In an embodiment, an automatic question can appear on the handheld device with the child's picture to request if any of the parents within this community have seen the child. The interfaces 32 of the other users provides for receiving input and communicating it to the community on whether or not a given user has seen the child providing fast communication between the members of the community. In the event the child returns to in range (on grid) then the interfaces are all signaled and the search is called off.

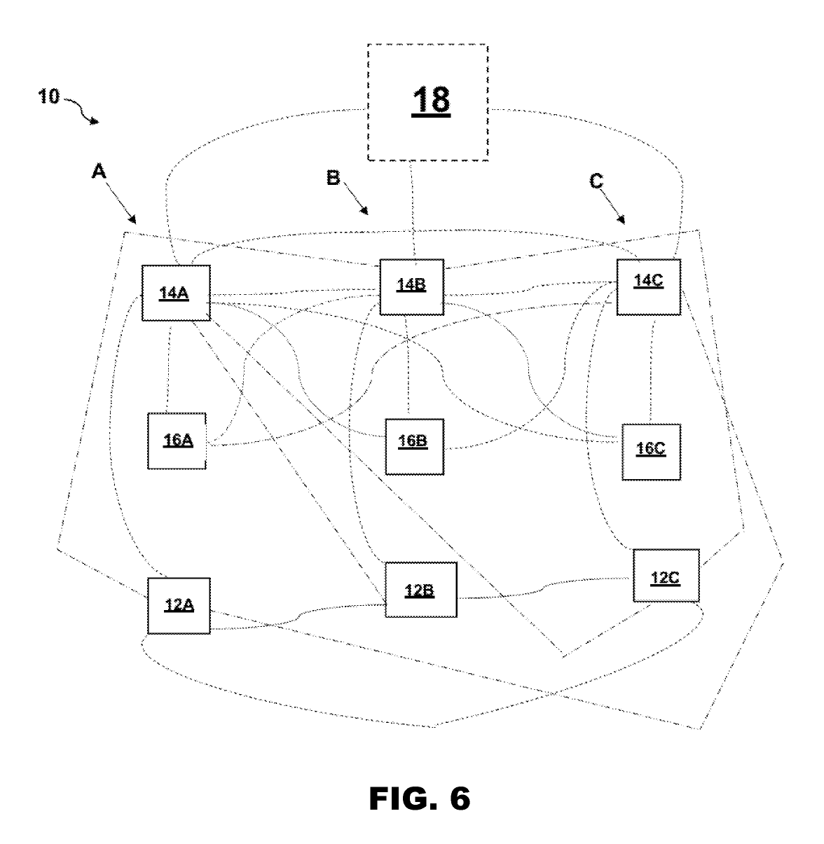

Turning to FIG. 6, there is shown a variety of possible communication links between the system 10 components (12, 14, 16 and 18) described above.

For example, the system 10 comprises a plurality of monitor controllers such as 14A, 14B and 14C, each of which are in operational communication with a respective interface 16A, 16B and 16C, respectively and in operational communication with a respective monitoring device 12A, 12B, and 12C, respectively. As such a given monitor controller, interface and device assembly, A (14A, 16A, 12A), B (14B, 16B, 12B) and C (14C, 16C, 12C) provides fora monitoring relationship between a given monitor and a given monitored subject as previously described.

In an embodiment, one or more assembly A, B and C is in operational communication with the system controller 18 via a respective monitor controller 14A, 14B and 14C. In an embodiment, a given monitor controller 14A, 14B and 14C is in operational communication with one or more of the other monitor controllers 14A, 14B and 14C directly and/or via the system controller 18.

In an embodiment, a given monitor controller 14A, 14B and 14C of a given assembly A, B and C is in operational communication with the interface 16A, 16B, 16C of one or more of the assemblies A, B and C directly and/or via the system controller 18. In an embodiment, a given monitor controller 14A, 14B and 14C of a given assembly A, B and C is in operational communication with the monitoring device 12A, 12B, 12C of one or more of the assemblies A, B and C directly and/or via the system controller 18.

In an embodiment, a given monitoring device 12A, 12B, 12C is in operational communication with one or more of the other monitoring devices 14A, 14B and 14C directly and/or via the system controller 18 and/or a given monitor controller 14A, 14B, 14C respectively.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1. A system for monitoring an individual comprising:
a controller arrangement comprising a memory of computer-implementable steps and a database of predetermined target conditions;
a monitoring device physically associated with the monitored individual and in communication with the controller, the monitoring device providing for detecting a real-time condition status of the monitored individual;
an interface accessible to a monitor of the individual being in communication with the controller arrangement and the monitoring device, the memory of computer implementable steps comprising:
receiving the real-time condition status from the monitoring device;
comparing the real-time condition status with the target conditions so as to identify a match;
signaling the monitor via the interface when a match between a given real-time condition status and a target condition has been made.

2. A system according to claim 1, wherein the target condition is selected from a group of conditions consisting of: an unauthorized distance between the monitoring device and the monitor, an unauthorized distance between the monitoring device and another element, an unauthorized location of the monitoring device, an unauthorized velocity of the monitoring device, an unauthorized motion of the monitoring device, a unauthorized moisture level of the monitoring device, an unauthorized temperature level of the device, an unauthorized light intensity in the ambient environment of the monitoring device, an unauthorized sound in the ambient environment of the monitoring device, an unauthorized word in the ambient environment of the monitoring device and any combination thereof.

3. A system according to claim 2, wherein one or more of the group of condition is considered a target condition based on one or more additional conditions selected from the group consisting of:
the duration of the condition;
the time of day of the condition;
the location of the condition;
the frequency of the condition; and
the concurrent presence of one or more other conditions of the group of conditions.

4. A system according to claim 2, wherein the another element is selected from the group consisting of a third-party controller, another monitoring device and a combination thereof.

5. A system according to claim 1, wherein a match is identified if at least one of the following parameters is satisfied:
if a given condition status matches a given target condition for a given time interval;
if a given condition status matches a given target condition during a given time of the day;
if a given condition status matches a given target condition at a given location;
if a given condition status concurrently matches at least two given target conditions; and
any combination thereof.

6. A system according to claim 1, wherein a match is identified if a given condition status matches a given target condition at a given location.

7. A system according to claim 1, wherein a match is identified is a given condition status concurrently matches at least two given target conditions.

6-7: (canceled)

8. A system according to claim 1, wherein the monitoring device is selected from the group consisting of: a GPS, a RFID unit, a Bluetooth unit, an emitter, a sensor, a detector, a moisture sensor, a motion detector, a light detector, a temperature detector, a microphone, an application running on the processor of a host device, a controller with a memory of computer implementable steps and any combination thereof.

9. A system according to claim 1, wherein the monitoring device is mounted to an appendage mounted or carried by the monitored individual, wherein the appendage is selected from the group consisting of: a bracelet, a necklace, a watch, eyewear, rings, earrings, headwear, shoes, a belt, clothing, socks, a shirt, a jacket, pants, underwear, accessories, a wallet, a bag, a handheld device, a smartphone, a tablet and any combination thereof.

10. A system according to claim 1, wherein the controller arrangement comprises a remote system controller in communication with a monitor controller in communication with the interface.

11. A system according to claim 10, wherein the memory of computer implementable steps is hosted on the system controller and/or the monitor controller.

12. A system according to claim 10, wherein the database of target conditions is hosted on the system controller and/or the monitor controller.

13. A system according to claim 1, further comprising:
a plurality of additional interfaces accessible to a network of users, the plurality of additional user interfaces being in communication with the controller arrangement.

14. A system according to claim 13, wherein the network of users or a selected sub-group thereof are selectively notified of the target condition via the plurality of additional interfaces.

15. A device for monitoring an individual comprising:
a monitor controller comprising a memory of computer-implementable steps and a database of predetermined target conditions;
a monitoring device physically associated with the monitored individual and in communication with the controller, the monitoring device providing for detecting a real-time condition status of the monitored individual;
an interface accessible to a monitor of the individual being in communication with the controller arrangement and the monitoring device, the memory of computer implementable steps comprising:
receiving the real-time condition status from the monitoring device;
comparing the real-time condition status with the target conditions so as to identify a match;
signaling the monitor via the interface when a match between a given real-time condition status and a target condition has been made.

16. A method for monitoring an individual comprising:
providing a database of predetermined target conditions;
detecting a real-time condition status of the monitored individual;
comparing the real-time condition status with the target conditions so as to identify a match; and
signaling a monitor via an interface accessible to the monitor when a match between a given real-time condition status and a target condition has been made.

17. A method according to claim 16, further comprising:
selectively notifying a plurality of selected method users via additional interfaces of the match.

18. A method according to claim 16, wherein the target condition is selected from a group of conditions consisting of: an unauthorized distance between the monitoring device and the monitor, an unauthorized distance between the monitoring device and another element, an unauthorized location of the monitoring device, an unauthorized velocity of the monitoring device, an unauthorized motion of the monitoring device, a unauthorized moisture level of the monitoring device, an unauthorized temperature level of the device, an unauthorized light intensity in the ambient environment of the monitoring device, an unauthorized sound in the ambient environment of the monitoring device, an unauthorized word in the ambient environment of the monitoring device and any combination thereof.

19. A method according to claim 18, wherein one or more of the group of condition is considered a target condition based on one or more additional conditions selected from the group consisting of:
the time frame of the condition;
the time of day of the condition;
the location of the condition;
the frequency of the condition; and
the concurrent presence of one or more other conditions of the group of conditions.

20. A method according to claim 18, wherein a match is identified if at least one of the following parameters is satisfied:
if a given condition status matches a given target condition for a given time interval;
if a given condition status matches a given target condition during a given time of the day;
if a given condition status matches a given target condition at a given location;
if a given condition status concurrently matches at least two given target conditions; and
any combination thereof.
